(19) United States
(12) Patent Application Publication
(10) Pub. No.: US 2023/0054640 A1
(43) Pub. Date: Feb. 23, 2023

(54) MACHINE WITH A TOOL ROTOR HAVING AT LEAST TWO HYDRAULIC MOTORS

(71) Applicant: SEPPI M. SPA, Caldaro sulla strada del vino (IT)

(72) Inventor: Lorenz SEPPI, Caldaro sulla strada del vino (IT)

(73) Assignee: SEPPI M. SPA, Caldaro sulla strada del vino (IT)

(21) Appl. No.: 17/874,378

(22) Filed: Jul. 27, 2022

(30) Foreign Application Priority Data
Jul. 30, 2021 (IT) 10 2021 000 020 4

(51) Int. Cl. B60K 17/10; B60K 17/28

(52) U.S. Cl. CPC B60K 17/10; B60K 17/28

(57) ABSTRACT

A machine with a tool rotor (100) comprising at least two hydraulic motors (112, 122), which are connected to each other and may be connected via at least one inlet conduit (201, 203,) and at least one outlet conduit (202, 204) with a hydraulic source of a machine (200) that carries and/or tows the machine (200) (100) and each hydraulic motor is respectively connected, via a taper roller bearing (111, 123) that supports a respective shaft (104, 107), with a belt drive (102, 103) that drives a shaft (108) of a tool rotor respectively connected to one end of the shaft (108) of the tool rotor (101). At least one distributor is interposed between the hydraulic motors, and remote electronic adjustment of displacement/volume of at least one hydraulic motor is controlled.

### BACKGROUND OF THE INVENTION

The present invention relates to a machine with a tool rotor having at least two hydraulic motors.

### TECHNICAL FIELD

The invention finds application in the field of agricultural machines, soil-working machines and the like. These machines feature a tool rotor for working soil and/or chipping or/and crushing material.

Such machines are parts of self-propelled machines or are carried thereby. They may be placed at the front of the machine or at the rear of the machine in the direction of travel.

### BACKGROUND ART

US 2009 005 12 10 discloses a road construction machine, namely a machine for road milling, material recycling or road stabilization. This machine has a mechanical actuator which moves the machine and actuates at least one hydraulic pump to drive the tools.

U.S. Pat. No. 7,810,888 discloses a road construction machine which also includes a hydraulic pump for driving the tool rotor.

All the above-mentioned machines are affected by the problem that the rotor can be only used in one direction of rotation and that the machines have a large size due to the presence of a large hydraulic motor. Furthermore, the machines are not easily adjusted to the torque required by the tool rotor.

### SUMMARY OF THE INVENTION

The object of the present invention is to provide a machine with a tool rotor having at least two hydraulic motors.

This object is achieved by a system as defined in the claims.

Herein disclosed is a machine with a tool rotor comprising at least two hydraulic motors connected to each other and connected via at least one inlet conduit and at least one outlet conduit with a hydraulic source of a machine that carries and/or tows the rotor, each hydraulic motor being supported by a taper roller bearing and actuating a tool rotor via a belt drive connected at one end.

According to the invention, at least one distributor, preferably an integral distributor, is located between the hydraulic motors, wherein remote electronic adjustment of at least the volume/displacement of at least one hydraulic motor is allowed. Due to the use of two hydraulic motors, at least one hydraulic motor always works at optimum efficiency while the other can be adjusted.

Advantageously, the volume/displacement of the second hydraulic motor that is not remotely controlled may be adjusted before use by mechanical adjustment.

The hydraulic motors are preferably powered by the machine that carries/tows the milling/chipping machine having the rotor tool.

Advantageously, both hydraulic motors have input and output ports for hydraulic motor supply.

Preferably both hydraulic motors have an integral distributor. For example, if the first motor is powered via the conduit of the hydraulic source of the towing machine, the second motor is powered via the integral distributor and vice versa.

Further objects, characteristics, advantages and application options result from the following description of a few exemplary embodiments and the accompanying drawings. Thus, all the characteristics as described and/or shown in the figures form by themselves or in any combination the object disclosed herein, also regardless of their being grouped in the claims or of their dependencies, whereas:

### DESCRIPTION OF THE DRAWINGS

FIG. 1 shows a diagram of two hydraulic motors at two different times of operation and

FIG. 2 is a schematic of the system for a machine of the invention.

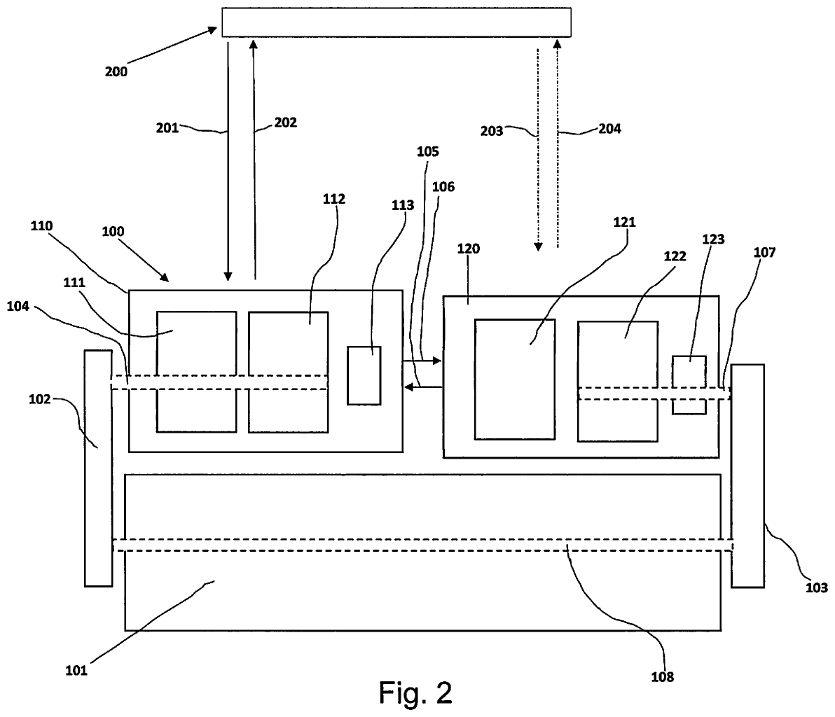

### DETAILED DESCRIPTION OF THE INVENTION

Numeral 100 designates a machine with a tool rotor 101 which comprises at least two hydraulic motors 112, 122. At least one hydraulic motor is connected via inlet conduits 201, 203 and outlet conduits 202, 204 with a machine 200 that carries the machine 100 with the tool rotor 101. The hydraulic circuit inside the machine 100 is fed via the conduits 201, 202, 203, 204.

The inlet conduit 201 feeds a first hydraulic motor unit 110 consisting of the hydraulic motor 112, which is connected via a shaft 104 carried by a first taper roller bearing 111 to, and actuates via a belt drive 102, one end of the shaft 108 of the tool rotor 101.

In addition, the hydraulic motor unit 110 has an integral distributor 113 that distributes the inflowing fluid between the first hydraulic motor 110 and the second hydraulic motor 122 arranged in the second hydraulic motor unit 120. The second hydraulic motor 122 is connected via a second taper roller bearing 123 with a belt drive 103 to the other end of the tool rotor 101.

Since both the first hydraulic motor 112 and the second hydraulic motor 122 drive the same rotor, the shafts 104,107 supported by the taper roller bearings 111,123 rotate at substantially the same speed.

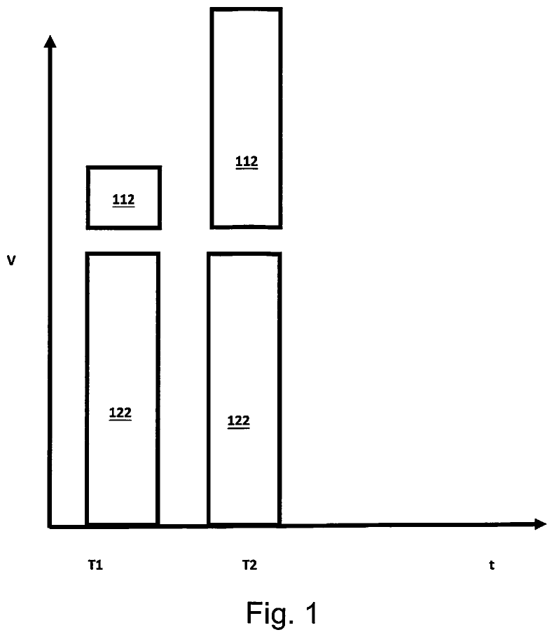

If the conduits 203, 204 feed the second hydraulic motor unit 122 and not the first hydraulic motor unit 110, the integral distributor 121 of the second motor unit 120 distributes the flow between the first and the second hydraulic motor units 110,120. Remote electronic adjustment of volume/displacement of at least one hydraulic motor 112,122 is provided, and FIG. 1 shows a situation 1 in which the hydraulic motor 112 has a small volume/displacement V at time T1 and the second hydraulic motor 122 has a larger volume/displacement at time T2 and the volume/displacement of the second motor remains constant while the volume/displacement of the first hydraulic motor is increased. This can increase the torque available to the tool rotor 101.

Advantageously, the volume/displacement of the second hydraulic motor 122 can be adjusted by mechanical means. For example, this affords adjustment of the base volume/displacement and hence the torque. The two hydraulic motors 112, 122 are connected to each other by connecting conduits 105, 106.

With the use of two hydraulic motors 112,122, at least one hydraulic motor 122 always works at optimum efficiency.

The tool rotor can be easily reoriented i.e. have its direction of rotation reversed, e.g. if the rotor is pulled in the first operation and carried at the front of the machine in the second operation, the direction of rotation of the rotor 101 can be easily changed. In a preferred embodiment the distributor 113, 121 may be the hydraulic motor 112,122.

In a further embodiment the distributor 113,121 is integrated in at least one hydraulic motor 112,122.

The above discussed variants of the machine are only provided for improved understanding of the structure, operation and properties of the solution as described; they do not limit the disclosure to the exemplary embodiments. The figures are schematic, the essential properties and effects being partially shown in a magnified size, to clearly highlight the functions, principles of action, configurations and technical characteristics. Thus, each operation, each principle, each technical configuration and each characteristic as disclosed in the figures or in the text, may be provided in any free combination with all the claims, and with each characteristic in the text and the other figures, other operations, principles, configurations and technical characteristics contained in this disclosure or resulting therefrom, wherefore every conceivable combination shall be deemed to be encompassed by the above-described solution. This also includes combinations of all the individual disclosures in the text, i.e. In each paragraph of the text, in the claims and also in combinations of different variants in the text, sizes and figures. The details of the above-described device and method are represented in the connection; nevertheless, it should be noted that they can be combined together even independent of each other and freely from each other. The ratios as shown in the figures of the individual parts and sections thereof and their sizes and proportions are not to be considered as limiting. Individual sizes and proportions may also differ from those as shown. The claims also do not limit the disclosure and hence the possibility to combine all the characteristics herein. All the characteristics herein are also disclosed individually and in combination with all the other characteristics.

### LIST OF REFERENCES

100 machine with tool rotor
101 tool rotor
102 belt drive
103 belt drive
104 shaft
105 connecting conduit
106 connecting conduit
107 shaft
108 shaft
110 first hydraulic motor unit
111 first taper roller bearing
112 first hydraulic motor
113 integral distributor
120 second hydraulic motor unit
121 integral distributor
122 second hydraulic motor
123 second taper roller bearing
200 machine
201 inlet conduit
202 outlet conduit
203 inlet conduit
204 outlet conduit

1. A machine with a tool rotor comprising at least two hydraulic motors, which are connected to each other and may be connected via at least one inlet conduit and at least one outlet conduit with a hydraulic source of a machine that carries and/or tows the machine with the tool rotor, and each hydraulic motor is respectively connected, via a taper roller bearing each supporting a respective shaft, with a belt drive that drives a shaft of the tool rotor respectively connected to one end of the shaft of the tool rotor, wherein at least one distributor is interposed between the at least two hydraulic motors, and remote electronic adjustment of displacement/volume of at least one hydraulic motor is controlled.

2. The machine with a tool rotor as claimed in claim 1, wherein the at least one distributor is the at least one hydraulic motor.

3. The machine with the tool rotor as claimed in claim 1, wherein the at least one distributor is integrated in at least one hydraulic motor.

4. The machine with the tool rotor as claimed in claim 1, wherein the displacement/volume of the at least one hydraulic motor that is not remotely controlled is mechanically adjustable.

5. The machine with the tool rotor as claimed in claim 1, wherein the at least two hydraulic motors have a port for an inlet conduit and an outlet conduit.
